(19) United States
(12) Patent Application Publication
(10) Pub. No.: US 2016/0196437 A1
(43) Pub. Date: Jul. 7, 2016

(54) METHOD OF USING TOUCH SCREEN DEVICE FOR SYSTEM ENCRYPTION AND PROTECTION

(71) Applicant: DONGGUAN LEVETOP TECHNOLOGY CO., LTD., Guangdong (CN)

(72) Inventors: Yulong Wang, Dongguan (CN); Bo Li, Dongguan (CN); Yongyao Zhi, Dongguan (CN); Shiping Tang, Dongguan (CN)

(21) Appl. No.: 14/916,294

(22) PCT Filed: Sep. 6, 2013
(86) PCT No.: PCT/CN2013/083043

§ 371 Date: Mar. 3, 2016

(51) Int. Cl. G06F 21/60; G06F 3/041; H04L 9/06; G06F 3/044

(52) U.S. Cl. CPC G06F 21/602; G06F 3/044; G06F 3/0416; H04L 9/0631

(57) ABSTRACT

A method of using touch screen device for system encryption and protection includes sending plaintext to a touch screen controller by a host; and receiving and encrypting the plaintext to generate ciphertext by the touch screen controller, and returning the ciphertext to the host, thus realizing encryption inside the touch screen device (the plaintext and the ciphertext are exchanged through communication interfaces of the host and the touch screen controller). The encrypting method enables important data (such as accounts or passwords) inputted by a user to be encrypted before being inputted into a system host, thereby preventing the important data from being stolen by malicious software when the data is being transmitted in the form of plaintext to an external encrypting device (such as a “dongle”), thus enhancing security of the touch screen device. Further the method facilitates system encryption of most handy devices and mobile devices.

### FIELD OF THE INVENTION

The present invention relates to technical field of encryption and, more particularly to a method of using touch screen device for system encryption and protection.

### BACKGROUND OF THE INVENTION

To prevent electronic products from being replicated illegally or restricting uncontrollable production of OEM, and protect intellectual property rights of the electronic product designer, it's necessary to encrypt the electronic products.

One of conventional encrypting means applies “dongle” which is a hardware inserting into an interface of an external device for electronic products. The nonvolatile memory in the “dongle” commonly provides reading or writing space ranging from tens to hundreds bytes. Some of “dongles” may include single chips, etc. During the operation, the “dongle” is connected to the mainboard of the system host via a bus of the external device. Software developer exchanges data with the “dongle” (such as reads or writes data) by interface function to check if the “dongle” is attached to the interface or not, or encrypts or decrypts the important data by means of the encryption and decryption algorithm in the “dongle”. In addition, the software developer may configure multiple software locks for the software, which is required a “dongle” to unlock. If the “dongle” is lost or not matched, the software could not run normally.

The above encryption manner has several divagates, although the system host can be protected: (1) since the “dongle” is connected to the host via the bus of the external device, thus the important data is easy to be stolen by malicious software when the data is transmitted to the “dongle” in the form of plaintext; (2) the “dongle” is built by EPROM or MCU, and anyone could design or manufacture the “dongle” by buying a general EPROM or MCU. Internal parameters in the “dongle” can be modified by firmware update, further the specification of the general EPROM or MCU are public and accessible, thus the “dongle” is easy to be cracked by reading the codes in the “dongle”, which leads a low security; (3) such a “dongle” requires a hardware device attached to the system, thus it is inconvenient for portable electronic equipments.

Thus there is a need to provide an improved encryption method to overcome the drawbacks, and suitable for portable electronic equipments.

### SUMMARY OF THE INVENTION

One Objective of the present invention is to provide a method of using touch screen device for system encryption and protection, thereby overcoming the drawbacks of the conventional encryption method, and preventing the important data from being stolen by malicious software when the data is being transmitted in the form of plaintext to an external encrypting device (such as a “dongle”), thus enhancing security of the portable devices.

To achieve the above-mentioned objective, a method of using touch screen device for system encryption and protection, includes sending plaintext to a touch screen controller by a host; and receiving and encrypting the plaintext to generate ciphertext by the touch screen controller, and returning the ciphertext to the host.

In comparison with the prior art, in the encryption method of the present invention, the touch screen controller in the touch screen device encrypts the plaintext from the host to generate ciphertext, and returns the ciphertext to the host, thus realizing encryption inside the touch screen device (the plaintext and the ciphertext are exchanged through communication interfaces of the system host and the touch screen controller). The encrypting method enables important data (such as accounts or passwords) inputted by a user to be encrypted before being inputted into a system host, thereby preventing the important data from being stolen by malicious software when the data is being transmitted in the form of plaintext to an external encrypting device (such as a “dongle”), thus enhancing security of the touch screen device.

As an embodiment of the present invention, the touch screen controller comprises a micro control unit adapted for receiving the plaintext, encrypting pre-stored encryption parameters, user passwords and user serial number according to key generation logic to generate an initial key, encrypting the initial key according to iterative encryption to generate the ciphertext, and returning the ciphertext to the host.

Preferably, the micro control unit receives the plaintext and sends the ciphertext by IIC interfaces, SPI interfaces or USB interfaces.

As another embodiment, the touch screen controller comprises an encryption core adapted for receiving the plaintext, encrypting pre-stored encryption parameters, user passwords and user serial number according to key generation logic to generate an initial key, encrypting the initial key according to iterative encryption to generate the ciphertext, and returning the ciphertext to the host.

Preferably, the encryption core receives the plaintext and sends the ciphertext by IIC interfaces, SPI interfaces or USB interfaces.

As another embodiment, the touch screen controller comprises a micro control unit and an encryption core, the encryption core receives the plaintext and encrypts pre-stored encryption parameters, user passwords and user serial number according to key generation logic to generate an initial key, and the micro control unit encrypts the initial key according to iterative encryption to generate the ciphertext and returns the ciphertext to the host.

Preferably, the encryption core receives the plaintext and sends the ciphertext by IIC interfaces, SPI interfaces or USB interfaces, and the micro control unit receives the plaintext and sends the ciphertext by IIC interfaces, SPI interfaces or USB interfaces.

Preferably, said encrypting the initial key according to iterative encryption to generate the ciphertext comprises encrypting the initial key according to key expansion logic to generate nine intermediate keys by the encryption core; and encrypting the plaintext, the initial key, the intermediate keys and iterative encryption parameters according to AES-128 iterative encryption algorithm to generate the ciphertext.

Preferably, the plaintext and the ciphertext are in 128 bit.

### BRIEF DESCRIPTION OF THE DRAWINGS

The accompanying drawings facilitate an understanding of the various embodiments of this invention. In such drawings:

FIG. 1 is a schematic view of a touch screen device in an encryption method according to a first embodiment of the present invention;

FIG. 2 is a flowchart of an encryption method by using a touch screen device according to a first embodiment of the present invention;

FIG. 3 is a schematic view of FIG. 2;

FIG. 4 is a flowchart of unlocking the system that is encrypted by the encryption method of the present invention;

FIG. 5 is a schematic view of a touch screen device in an encryption method according to a second embodiment of the present invention;

FIG. 6 is a flowchart of an encryption method by using a touch screen device according to a second embodiment of the present invention;

FIG. 7 is a schematic view of a touch screen device in an encryption method according to a third embodiment of the present invention; and

FIG. 8 is a flowchart of an encryption method by using a touch screen device according to a third embodiment of the present invention.

### DETAILED DESCRIPTION OF ILLUSTRATED EMBODIMENTS

Various preferred embodiments of the invention will now be described with reference to the figures, wherein like reference numerals designate similar parts throughout the various views.

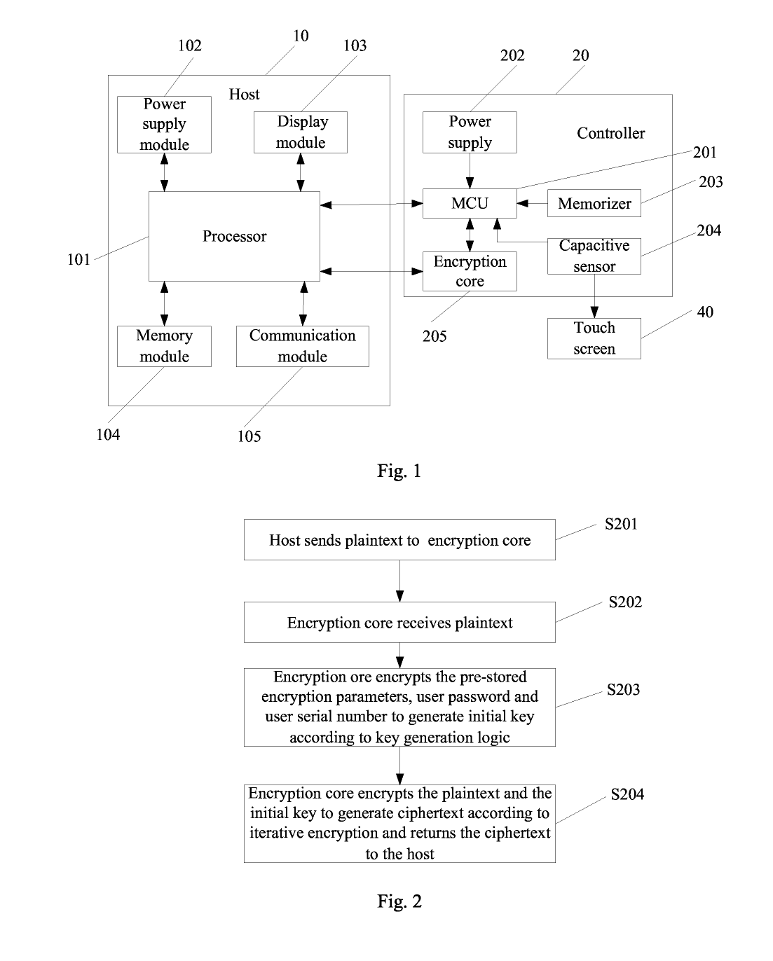

Referring to FIG. 1, a touch screen device in an encryption method according to a first embodiment of the present invention includes a host 10, a touch screen controller 20 and a touch screen 40. The host 10 includes a processor 101, and a power supply module 102, a display module 103, a memory module 104 and a communication module 105 which are connected with the processor 101 respectively. The touch screen controller 20 includes a micro control unit (MCU) 201, and a power supply 202, a memorizer 203, a capacitive sensor 204 and an encryption core 205 which are connected with the MCU 201 respectively, and the capacitive sensor 204 is connected with the touch screen 40. The processor 101 of the host 10 performs data exchange with the MCU 201 and the encryption core 205 via IIC interfaces (SPI interfaces, or USB interface, etc.), and the MCU 201 and the encryption core 205 share the rest circuit communicated with the processor 101.

It should be noted that, the touch screen in the embodiment is a projected capacitive screen.

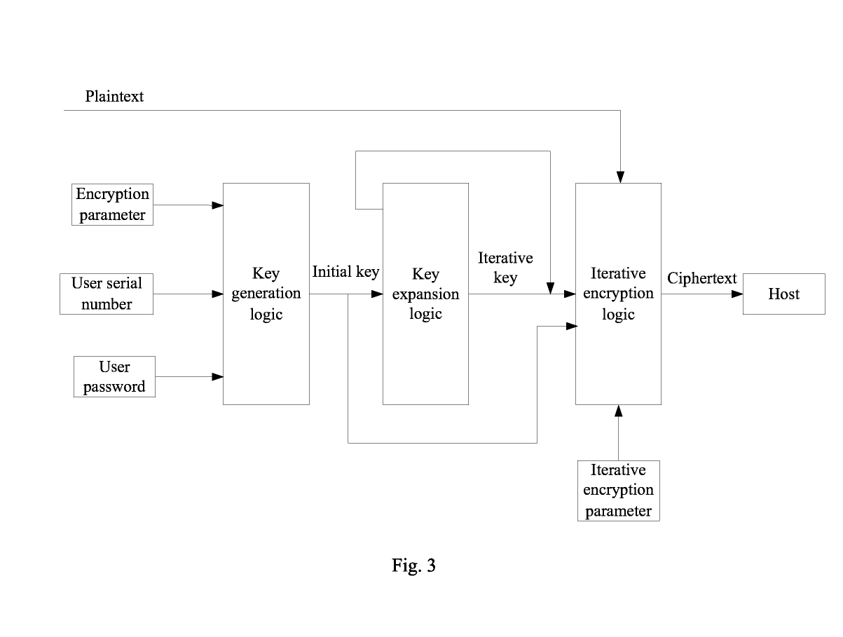

Please refer to FIGS. 2 and 3, the flowchart of an encryption method by using a touch screen device includes the following steps.

S201, the host sends plaintext to the encryption core which is integrated in the touch screen controller. Specifically, during the design, multiple dongles will be hidden in software in the processor 101 of the host 10, and one or more plaintext with 128 bits will be generated after the dongle is started. The plaintext is transmitted to the encryption core 205 integrated in the touch screen controller 20 via IIC interfaces.

S202, the encryption core receives the plaintext.

S203, the encryption core encrypts the pre-stored encryption parameters, user password and user serial number to generate initial key according to key generation logic. Specifically, the initial key is in 128 bit.

S204, the encryption core encrypts the plaintext and the initial key to generate ciphertext according to iterative encryption and returns the ciphertext to the host, in such a way, the data encryption is accomplished. Specifically, the ciphertext is 128bits. In this embodiment, AEC-128 encryption algorithm is used Specifically, according to key expansion logic, the encryption core encrypts the initial key to generate nine intermediate keys that is required in the iteration, and then implements ten iterations with the plaintext, initial key, nine intermediate keys and the iterative encryption parameters to finally generate the ciphertext which is then returned to the host via IIC interfaces.

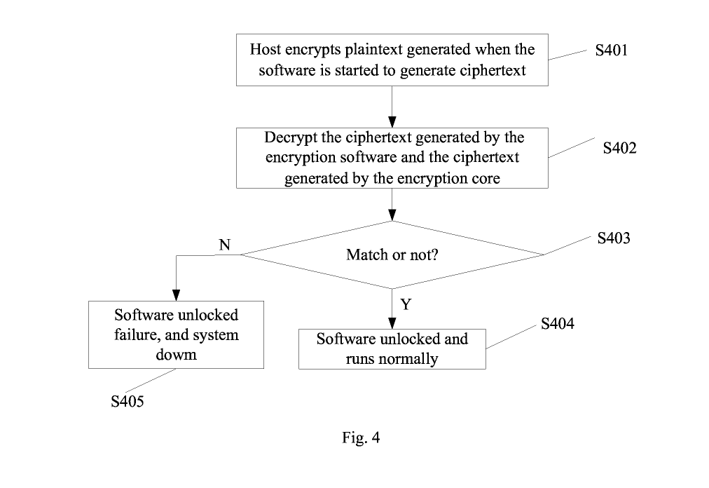

FIG. 4 shows the decryption flowchart after the above encryption method, the method includes the following steps.

S401, the host encrypts plaintext generated when the software is started to generate ciphertext. Specifically, when the software is to be unlocked, the encryption software in the host will encrypt the plaintext again, by using an encryption key which is produced by encrypting user serial number and user password stored in the host.

S402, decrypt the ciphertext generated by the encryption software and the ciphertext generated by the encryption core. Specifically, both of the ciphertext are decrypted by using ciphertext decryption process.

S403, judge the both are matched or not, if yes, implement S404, otherwise implement S405.

S404, unlock the software, then the software runs normally.

S405, the software fails to be unlocked, and the system is down.

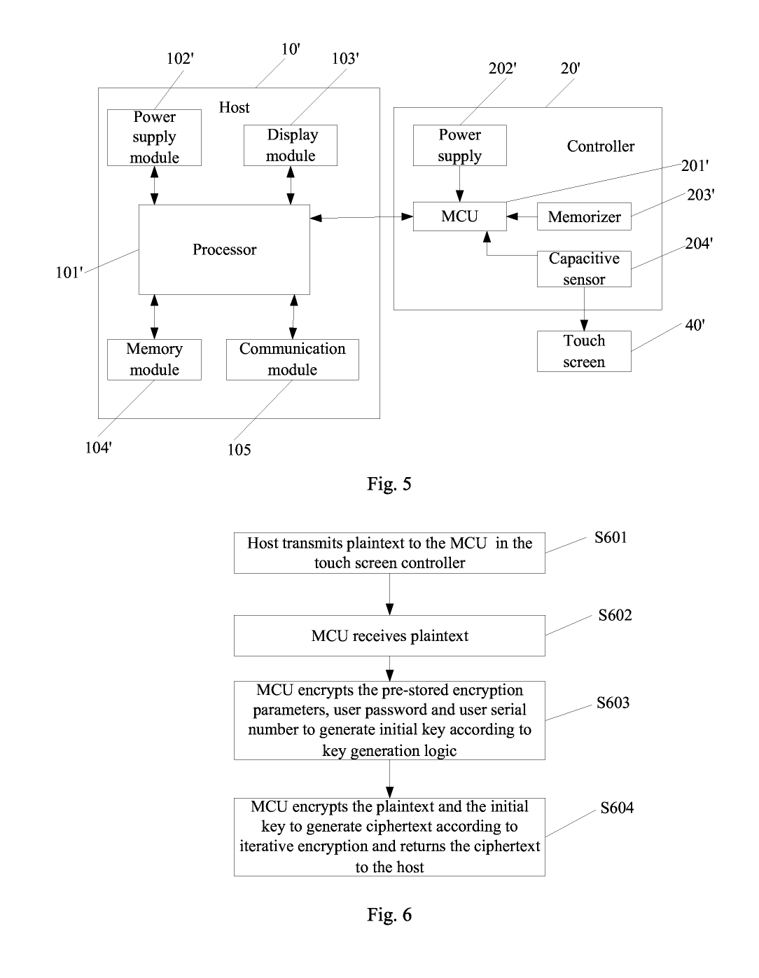

Referring to FIG. 5, the touch screen device according to the second embodiment includes a host 10′, a touch screen controller 20′ and a touch screen 40′. Differed from the first embodiment, the touch screen controller 20′ of the present embodiment has a micro controller unit 201′ for receiving plaintext and sending ciphertext, instead of an encryption core. The rest is the same with the first embodiment, which is not repeated here.

Referring to FIG. 6, the encryption method by using a touch screen device includes the following steps.

S601, the host sends plaintext to the MCU in the touch screen controller.

S602, the MCU receives the plaintext.

S603, the MCU encrypts the pre-stored encryption parameters, user passwords and user serial number to generate initial key according to key generation logic. Specifically, the initial key is in128 bit.

S604, the MCU encrypts the plaintext and the initial key to generate ciphertext according to iterative encryption and returns the ciphertext to the host, in such a way, the data encryption is accomplished. Specifically, the ciphertext is 128bits. In this embodiment, AEC-128 encryption algorithm is applied. Specifically, according to key expansion logic, the encryption core encrypts the initial key to generate nine intermediate keys that is required in the iteration, and then implements ten iterations with the plaintext, initial key, nine intermediate keys and the iterative encryption parameters to finally generate the ciphertext which is then returned to the host via IIC interfaces.

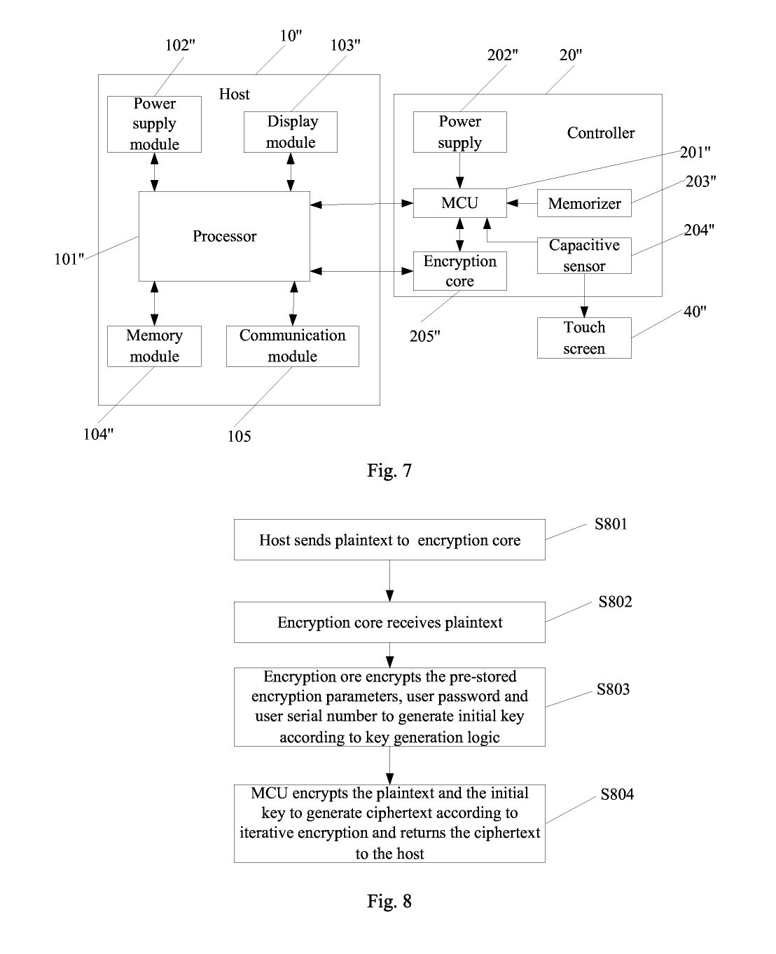

Referring to FIG. 7, the touch screen device according to a third embodiment includes a host 10″, a touch screen controller 20″ and a touch screen 40″. Differed from the first embodiment, the encryption core 205″ in the present embodiment is adapted for receiving the plaintext, and the MCU 201″ is adapted for sending the ciphertext. The rest is the same with the first embodiment, which is not repeated here.

Referring to FIG. 8, the encryption method by using a touch screen device includes the following steps.

S801, the host sends plaintext to the encryption core.

S802, the encryption core receives the plaintext.

S803, the encryption core encrypts the pre-stored encryption parameters, user password and user serial number to generate initial key according to key generation logic. Specifically, the initial key is in 128 bit.

S804, the MCU encrypts the plaintext and the initial key to generate ciphertext according to iterative encryption and returns the ciphertext to the host, in such a way, the data encryption is accomplished. Specifically, the ciphertext is 128bits. In this embodiment, AEC-128 encryption algorithm is applied. Specifically, according to key expansion logic, the encryption core encrypts the initial key to generate nine intermediate keys that are required in the iteration, and then implements ten iterations with the plaintext, initial key, nine intermediate keys and the iterative encryption parameters to finally generate the ciphertext which is then returned to the host via IIC interfaces.

It should be noted that, the operation principle and unlocking process in the second and the third embodiments are the same with that in the first embodiment, which are not repeated here therefore.

By this token, the first embodiment of the present invention applies hardware encrypting means, which encrypts the plaintext from the host inside the touch screen device without changing the mainboard design, thereby enhancing the security of the touch screen device and improving flexibility of the encrypting method. The second embodiment of the present invention applies software encrypting means, which encrypts the plaintext from the host inside the touch screen device, thereby enhancing the security of the touch screen device and improving the flexibility. The third embodiment of the present invention applies an encrypting means with combined software and hardware (encryption core and MCU), to encrypt the plaintext from the host inside the touch screen device, and the encrypting software and encrypting hardware are hidden in the massive circuits and data, thus it could hardly crack the encrypting software and hardware by reverse method, in such a way, the security of data is ensured and the flexibility is improved, further no change is made to the mainboard.

In conclusion, the encrypting method realizes encryption in the touch screen device to protect the system, and enables important data (such as accounts or passwords) inputted by a user to be encrypted before being inputted into a system host, thereby preventing the important data from being stolen by malicious software when the data is being transmitted in the form of plaintext to an external encrypting device (such as a “dongle”), thus enhancing security of the touch screen device. Furthermore, the present invention facilitates system encryption of most handled devices and mobile devices.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A method of using touch screen device for system encryption and protection, comprising:
sending plaintext to a touch screen controller and an encryption software by a host;
encrypting the plaintext to generate first ciphertext by the encrypting software;
receiving and encrypting the plaintext to generate second ciphertext by the touch screen controller, and returning the second ciphertext to the host, and the touch screen controller having an encrypting core integrated; and
decrypting the first ciphertex and the second ciphertext by the host to realize unlocking.

2. The method according to claim 1, wherein the touch screen controller comprises a micro control unit adapted for receiving the plaintext, encrypting pre-stored encryption parameters, user password and user serial number according to key generation logic to generate an initial key, encrypting the initial key according to iterative encryption to generate the second ciphertext, and returning the second ciphertext to the host.

3. The method according to claim 2, wherein the micro control unit receives the plaintext and sends the second ciphertext by IIC interfaces, SPI interfaces or USB interfaces.

4. The method according to claim 1, wherein the touch screen controller comprises an encryption core adapted for receiving the plaintext, encrypting pre-stored encryption parameters, user passwords and user serial number according to key generation logic to generate an initial key, encrypting the initial key according to iterative encryption to generate the second ciphertext, and returning the second ciphertext to the host.

5. The method according to claim 4, wherein the encryption core receives the plaintext and sends the second ciphertext by IIC interfaces, SPI interfaces or USB interfaces.

6. The method according to claim 1, wherein the touch screen controller comprises a micro control unit and an encryption core, the encryption core receives the plaintext and encrypts pre-stored encryption parameters, user passwords and user serial number according to key generation logic to generate an initial key, and the micro control unit encrypts the initial key according to iterative encryption to generate the second ciphertext and returns the ciphertext to the host.

7. The method according to claim 6, wherein the encryption core receives the plaintext and sends the ciphertext by IIC interfaces, SPI interfaces or USB interfaces, and the micro control unit receives the plaintext and sends the second ciphertext by IIC interfaces, SPI interfaces or USB interfaces.

8. The method according to any one of claims 2 to 7, wherein said encrypting the initial key according to iterative encryption to generate the second ciphertext comprises:
encrypting the initial key according to key expansion logic to generate nine intermediate keys by the encryption core; and
encrypting the plaintext, the initial key, the intermediate keys and iterative encryption parameters according to AES-128 iterative encryption algorithm to generate the second ciphertext.

9. The method according to claim 8, wherein the plaintext and the ciphertext are in 128 bit.
